(19) United States
(12) Patent Application Publication
(10) Pub. No.: US 2017/0299723 A1
(43) Pub. Date: Oct. 19, 2017

(54) System and Method for Pressure Altitude Correction

(71) Applicant: NavWorx Incorporated, Rowlett, TX (US)

(72) Inventor: Bill Moffitt, Rowlett, TX (US)

(21) Appl. No.: 15/636,341

(22) Filed: Jun. 28, 2017

Related U.S. Application Data
(63) Continuation-in-part of application No. 14/454,544, filed on Aug. 7, 2014, now Pat. No. 9,720,079.
(60) Provisional application No. 61/863,592, filed on Aug. 8, 2013.

(51) Int. Cl. G01S 19/03; G01S 13/91; G01S 13/82

(52) U.S. Cl. CPC G01S 19/03; G01S 13/825; G01S 13/91

(57) ABSTRACT

Transponder transmissions may be monitored through a direct, shielded connection of an RF coupler to a transponder antenna cable. The transponder interrogated pressure altitude may quickly change and measuring accurate data including position and pressure altitude is critical. A global positioning system (GPS) may be onboard a universal access transceiver (UAT) and may be utilized to correct the transponder interrogated pressure altitude and position. The UAT may transmit data that may include a corrected pressure altitude and a subsequent position to improve air traffic control radar beacon systems (ATCRBS).

### CROSS REFERENCE TO RELATED APPLICATIONS

This application is a continuation-in-part of U.S. application Ser. No. 14/454,544 filed Aug. 7, 2014, entitled “System and Method of Monitoring Transponder Transmissions,” and U.S. Provisional Application No. 61/863,592 filed Aug. 8, 2013, entitled “System and Method of Monitoring Transponder Transmissions,” both of which are incorporated herein by reference in their entirety.

### FIELD OF THE DISCLOSURE

The present disclosure generally relates to monitoring transponder transmissions without first interrogating the transponder, and more particularly to monitoring transponder transmissions through a direct connection of a shielded RF coupler to a transponder antenna cable.

### BACKGROUND

Traditional transponders used in air traffic control radar beacon systems (ATCRBS) for air traffic control (ATC) generally operate such that an encoder may be connected to and in communication with a transponder typically mounted in an instrument panel or avionics rack of an aircraft. ATCRBS can consist of a ground radar that can rotate at a fixed rate to interrogate transponders aboard cooperating aircraft. The transponder may transmit various codes, including Mode A (reply) codes and Mode C (altitude) codes, but, there is not a mechanism to delineate between these codes (i.e., whether a Mode A code is indeed a Mode A code and not a Mode C code). Additionally, the transponder can transmit encoded information about the aircraft, such as aircraft identification and pressure altitude.

Several problems arise from the nature of the design of older-style transponders. Transponders generally transmit information about altitude, and a reply code, assigned by ATC, for use by the ATCRBS. An altitude encoder device separate from the transponder can provide the pressure altitude which may be read by the transponder. The encoder is generally external to the transponder, and most encoders utilize a parallel wiring mechanism to transfer a Gillham encoded altitude to the transponder. However, if one or more of the parallel wires breaks, or the transponder inputs connected to these parallel wires fail, then the transponder (and ultimately the pilot) may be unable to ascertain whether the altitude information being transmitted to ATC is valid. Additionally, because the transponder interrogated pressure altitude can change every 12 seconds, the pressure altitude or the data transmitted can be stale. Older-style transponders also generally use all mechanical means for entry of a reply code, and there is no feedback to the pilot as to the reply code that may be transmitted. For example, if the indicator is integral to the mechanical switch, the switch can fail such that the mechanically connected indicator shows the change, but the transponder circuitry would not detect the change of the failed mechanical switch contacts. Accordingly, the ATC system may be burdened when these older-style transponders fail and transmit false altitude and/or reply codes. Modern transponders generally address these problems by being able to capture altitude and reply codes and show them to the operator or by changing the transponder design; however, the majority of aircraft in operation today utilize these older-style transponders.

### SUMMARY

Embodiments of the present disclosure may provide a transponder monitoring system for correcting pressure altitude. The system may provide a transponder that may transmit a signal to an air traffic control station. A plurality of transmitters may transmit an initial position and a first transponder interrogated pressure altitude. A global positioning system (GPS) may automatically correct the first transponder interrogated pressure altitude to a corrected pressure altitude and determine a subsequent position. The system may provide an air traffic control ground radar that may rotate at a fixed rate and interrogate the transponder. The corrected pressure altitude and the subsequent position may be automatically recorded when the transponder is interrogated by the air traffic control ground radar. The transponder may transmit encoded information that may include the initial position and the first transponder interrogated pressure altitude. The system may provide GPS updates and the GPS may determine the subsequent position and correct the first transponder interrogated pressure altitude to the corrected pressure altitude approximately every second. An RF coupler may be provided to monitor transponder transmissions, decode the first transponder interrogated pressure altitude and the corrected pressure altitude, a reply code and identity information, and transmit the first transponder interrogated pressure altitude and the corrected pressure altitude, and the reply code and identity information digitally for use by a transceiver. An ADS-B OUT transmitter may be provided to transmit the corrected pressure altitude. The corrected pressure altitude may be a sum of the first transponder interrogated pressure altitude and the subsequent position minus the initial position which may be represented by T(n)=TIPA+GPS(n)−GPS(0). The system may provide that the initial position may be determined when zero seconds have elapsed and the air traffic control ground radar may interrogate the transponder and a connected pressure altitude encoder.

Other embodiments of the present disclosure may provide a method for correcting pressure altitude. The method may include the steps of transmitting a signal to an air traffic control station using a transponder. The method may provide the step of transmitting an initial position and a first transponder interrogated pressure altitude using a plurality of transmitters and automatically determining the subsequent position and correcting the first transponder interrogated pressure altitude to a corrected pressure altitude using a global positioning system (GPS). The method may include the step of rotating an air traffic control ground radar at a fixed rate and interrogating the transponder. The method may include the step of automatically recording the subsequent position and the corrected pressure altitude when the transponder is interrogated by the air traffic control ground radar. The method may provide the step of transmitting encoded information by the transponder, and the encoded information may include the initial position and the first transponder interrogated pressure altitude. The method may also provide the step of updating the first position and the first transponder interrogated pressure altitude to the updated position and the corrected pressure altitude approximately every second using the GPS. The method may include the step of monitoring transponder transmissions, decoding the first transponder interrogated pressure altitude, the corrected pressure altitude, a reply code and identity information, and transmitting the first transponder interrogated pressure altitude, the corrected pressure altitude, the reply code and identity information digitally for use by a transceiver using an RF coupler. The method may provide the steps of transmitting the corrected pressure altitude using an ADS-B OUT transmitter and calculating, by a computer, the corrected pressure altitude, and the corrected pressure altitude may be a sum of the first transponder interrogated pressure altitude and the updated position minus the first position calculated which may be represented by T(n)=TIPA+GPS(n)−GPS(0). The method may provide the step of calculating, by a computer, the first position when zero seconds have elapsed and the air traffic control ground radar may interrogate the transponder and a connected pressure altitude encoder.

Further embodiments of the present disclosure may provide a pressure altitude correction device that may include a transponder that may be provided to transmit a signal to an air traffic control station. The device may include a plurality of transmitters that may be provided to transmit a first position and a first transponder interrogated pressure altitude. A global positioning system (GPS) may be provided to automatically update the first position to an updated position and the first transponder interrogated pressure altitude to a corrected pressure altitude. The device may include an RF coupler that may be provided to monitor transponder transmissions, decode the first transponder interrogated pressure altitude, the corrected pressure altitude, a reply code and identity information, and transmit the first transponder interrogated pressure altitude, the corrected pressure altitude, the reply code and identity information digitally for use by a transceiver. The device may provide an ADS-B OUT transmitter provided to transmit the corrected pressure altitude, and the corrected pressure altitude may be a sum of the first transponder interrogated pressure altitude and the updated position minus the first position. An equation, T(n)=TIPA+GPSA(n)−GPSA(0), may be used to determine the corrected pressure altitude. The device may provide the first position may be determined when zero seconds have elapsed and the air traffic control ground radar may interrogate the transponder and a connected pressure altitude encoder.

### BRIEF DESCRIPTION OF THE DRAWINGS

For a more complete understanding of this disclosure, reference is now made to the following description, taken in conjunction with the accompanying drawings, in which:

FIG. 1 depicts a system for monitoring transponder transmissions through a direct connection of an RF coupler to a transponder antenna cable according to an embodiment of the present disclosure;

FIG. 2A depicts a direct, simple monitoring mechanism according to an embodiment of the present disclosure;

FIG. 2B depicts a direct, complex monitoring mechanism according to an embodiment of the present disclosure;

FIG. 2C depicts an indirect, complex monitoring mechanism according to an embodiment of the present disclosure;

FIG. 3 depicts interrogated pressure altitude over time according to an embodiment of the present disclosure; and

FIG. 4 depicts transponder interrogated pressure altitude (TIPA) over time including GPS altitude correction according to an embodiment of the present disclosure.

### DETAILED DESCRIPTION

Embodiments of the present disclosure may allow older-style transponders to have the ability to verify the altitude and reply codes being sent to air traffic control (ATC) without having to be replaced by a modern transponder. More specifically, if an aircraft is equipped with an older-style Mode C transponder, a transponder monitoring device (referred to herein as the TransMon) may be installed as the control input for a transceiver, such as an ADS600-B. The TransMon is a standalone device that may monitor transponder transmissions through a shielded RF coupler connection to an aircraft's transponder antenna coaxial cable. The TransMon device may be attached to the existing transponder antenna coaxial cable of a Mode C transponder to pick up altitude, reply codes and/or identity information, decode the information, and transmit it digitally for use by a transceiver, such as an ADS600-B, or another separate external monitor (e.g., existing EFIS, MFD, PFD or purpose-built display).

It should be appreciated that monitoring of old-style transponders and altitude encoders connected to old-style transponders may be performed in a variety of manners without departing from the present disclosure. These techniques may include, but are not necessarily limited to, direct, simple monitoring; direct, complex monitoring; and indirect, complex monitoring. Each of these techniques may be described in more detail below.

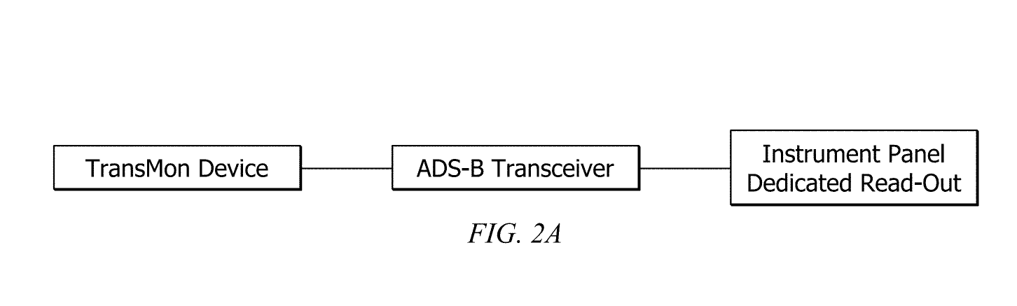

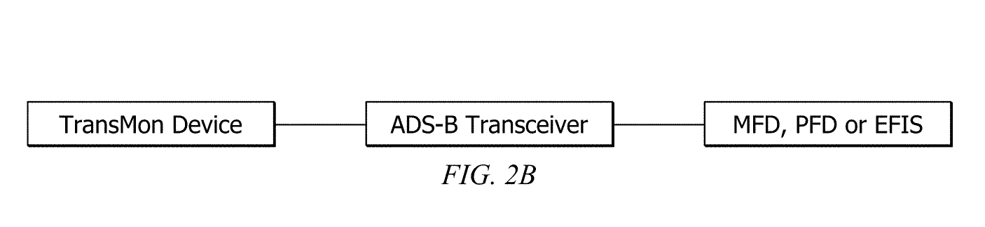

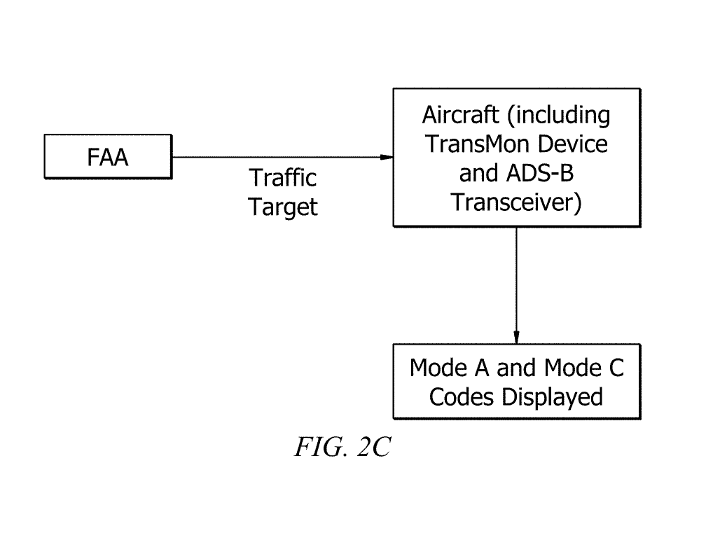

In an embodiment of the present disclosure, a direct, simple monitoring technique may be employed as depicted in FIG. 2A. Using this technique, the TransMon device may be connected to an ADS-B transceiver, such as an ADS600-B, and the ADS-B transceiver may be connected to an instrument panel dedicated read-out.

In another embodiment of the present disclosure, a direct, complex monitoring technique may be employed as depicted in FIG. 2B wherein the TransMon device may be connected to an ADS-B transceiver, and the ADS-B transceiver may be connected to a multi-function display (MFD), a primary flight display (PFD) or another electronic flight instrument system (EFIS). The MFD, PFD or EFIS may be programmed to show the Mode A and Mode C codes that may be transmitted by the TransMon device according to an embodiment of the present disclosure.

In a further embodiment of the present disclosure, an indirect, complex monitoring technique may be employed as depicted in FIG. 2C. This embodiment of the present disclosure takes into account the situation wherein an ADS-B transceiver may form part of an FAA ADS-B system. When the ADS-B transceiver is part of such a system, the FAA may send back traffic targets for ADS-B equipped aircraft. When a TransMon device is employed with the ADS-B transceiver, a traffic target may be received for an aircraft in which the ADS-B transceiver and the TransMon device are installed. Once the traffic target has been received, the associated Mode A and Mode C codes may be displayed from the FAA ADS-B transmitted message, and this information may be presented to a pilot so that he/she may cross-check the information against what is being shown on a transponder.

While various monitoring techniques have been described, it should be appreciated that other monitoring techniques may be utilized without departing from the present disclosure. Further, more or fewer devices/mechanisms may be utilized for monitoring without departing from the present disclosure.

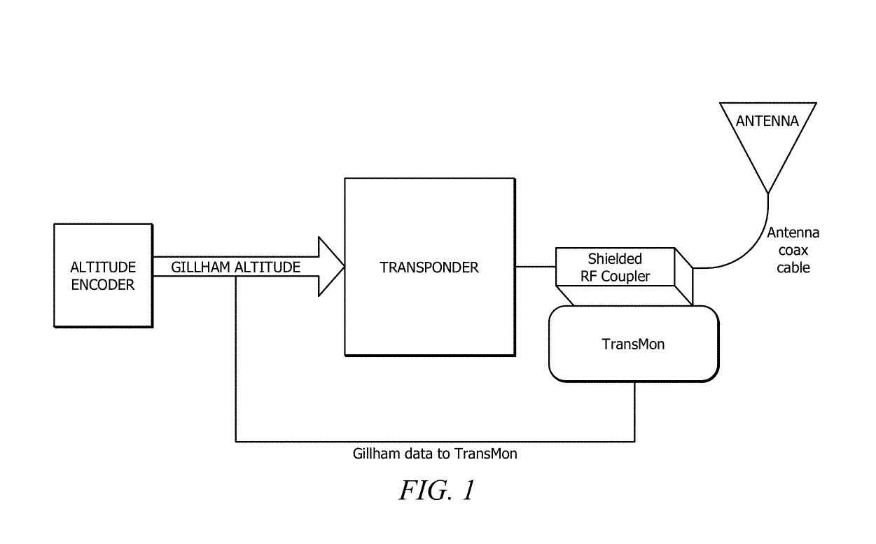

A means for monitoring the transponder transmissions according to embodiments of the present disclosure is through use of the TransMon device via a shielded RF coupler as depicted in FIG. 1. Receiving and decoding the timing bits may be accomplished by programmable hardware and/or software. The software may provide the mechanism to transmit the data digitally out of the TransMon device. By virtue of the direct shielded connection of the RF coupler to the transponder antenna cable, no transmissions of other transponders would be received.

In embodiments of the present disclosure, a transponder may transmit both Mode A (reply) and Mode C (altitude) codes in response to it being interrogated. The data output from the transponder may remain in the same format regardless whether the transponder is transmitting reply or altitude codes. To distinguish between reply or altitude codes, one has to know what type of interrogation that the transponder received and is replying to (i.e., Mode A or Mode C). Because the encoder feeds into the transponder as well as into the TransMon device via an RF coupler, it can distinguish whether a Mode A code is actually a Mode A code and not a Mode C code. This may be helpful insofar as when the transponder transmits either a Mode A or C code, the format of the data is the same, but the TransMon device can cross check using the encoder data.

The TransMon device does not listen to what interrogations the transponder is receiving because it would not know if it was intended for this specific transponder or for a transponder on another aircraft. Accordingly, the TransMon device must be clever to distinguish between the altitude code and the reply code and vice versa. Because there is no difference in the output format between the Mode A and the Mode C codes, the TransMon device may determine what is received based on several factors. The TransMon device monitors the data being transmitted by the transponder. The TransMon device may use a shielded “antenna” (wire), acting as an RF coupler, so that only certain transponder transmissions may be received. The TransMon device does not disturb the existing transponder system so it may reduce costs.

In one scenario, various A, B, C, and D bits may be transmitted by the transponder, and as such, 4096 possible codes may be emitted. Mode A (reply) codes may use all 4096 possible codes while Mode C (altitude) codes may require only 1280 codes. In this scenario, any code received by the TransMon device that is not a valid altitude code may be considered a squawk code. The 1280 codes represent altitudes from −1200 to 126,700 in 100-foot increments [126,700−(−1200)=128,000/100=1280]. Certain ADS-B products (such as the Universal Access Transceivers [UAT]) can only be used up to a certain altitude (such as 18,000 feet). Accordingly, the altitude codes may be limited to those that would realistically be transmitted by the transponder, when a UAT ADS-B device is installed in an aircraft, so 1280 codes may be limited to 212 codes that may represent −1200 up to 20,000 feet [20,000−(−1200)=21,200/100=212]. The final determinate to distinguish whether the transponder code is a squawk or an altitude code is to cross-check against the aircraft's altitude encoder. The Federal Aviation Administration (FAA) requires that both the transponder and ADS-B radios utilize the same altitude encoder. If the transponder code has not been ruled to be a squawk code by the above procedures, then a check of the altitude encoder against the code should identify whether it is an altitude code (i.e., it matches) or a squawk code (i.e., does not match). By using these procedures, the FAA may be more likely to certify the TransMon device.

In another embodiment of the present disclosure, the output of the altitude encoder may be used to cross check to ensure that the Mode A code is indeed the Mode A code and not a C code that maps to an A code.

It should be appreciated that embodiments of the present disclosure may provide the ability to discern a Mode A from a Mode C code without interrogating the transponder. This is a departure from previous devices that may interrogate a transponder in order to discern the Mode A or Mode C code received from the transponder.

It also should be appreciated that different methods may be used to discern the Mode A (squawk) from the Mode C (altitude) codes, including using the altitude encoder connected to a TransMon device to cross-check the altitude code coming from the received reply. If the altitude code matches with what the altitude encoder has read, then the code received is identified as an altitude Mode C reply code, and any different code would be confirmed as a squawk Mode A reply code. However, in some embodiments of the present disclosure, the altitude encoder cross-check mode may be eliminated but the two reply codes may still be accurately discerned. This may save the cost of installing a device to monitor the altitude encoder by the TransMon device in certain aircraft. In another method, the two codes may be discerned by understanding how radars work. Radars are all programmed to interrogate more Mode A reply codes than Mode C reply codes. Using this information, if two different reply codes both map to an altitude, and an altitude cross-check is not used, then a situation may arise wherein the correct Mode A may not be discerned from the Mode C. However, by knowing that the radar interrogates Mode A more times than Mode C, the reply codes may be accurately identified.

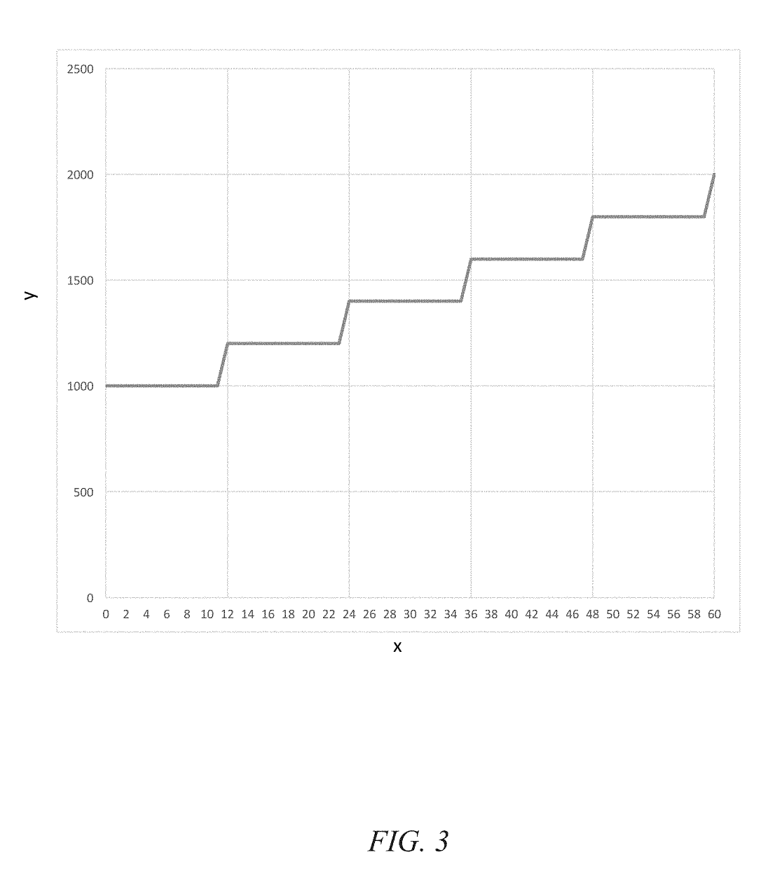

In embodiments of the present disclosure, an interrogated pressure altitude (y) over time (x) may be calculated for transceiver transmissions, such as for an ADS-B transmitter, as depicted in FIG. 3. An ATCRBS radar may interrogate a transponder and may provide pressure altitude output for air traffic control. The ATCRBS may interrogate an aircraft transponder approximately every 12 seconds. It should be appreciated that the ATCRBS may interrogate an aircraft transponder at predetermined points in time without departing from the present disclosure. It should further be appreciated that the ATCRBS may interrogate an aircraft transponder for more or less than approximately every 12 seconds without departing from the present disclosure. It should be appreciated that the ATCRBS may calculate a rate of climb (ROC) by calculating a change of altitude between successive radar interrogations. The ROC may be calculated by dividing time between successive interrogations and a change in altitude (e.g., Δ Altitude/Time Between Interrogations), wherein time between interrogations may typically be measured in seconds. This process may break down when using the interrogated transponder pressure altitude for ADS-B. The ADS-B transceiver output typically transmits aircraft information each second, and the ATC may compute ROC every second, expecting that ADS-B transmitted pressure altitude may be updated every second. As the transponder interrogated pressure altitude may change every 12 seconds, the ADS-B output transmitter may end up sending “stale” data for 11 out of 12 seconds, updating with the current pressure altitude once each 12 seconds.

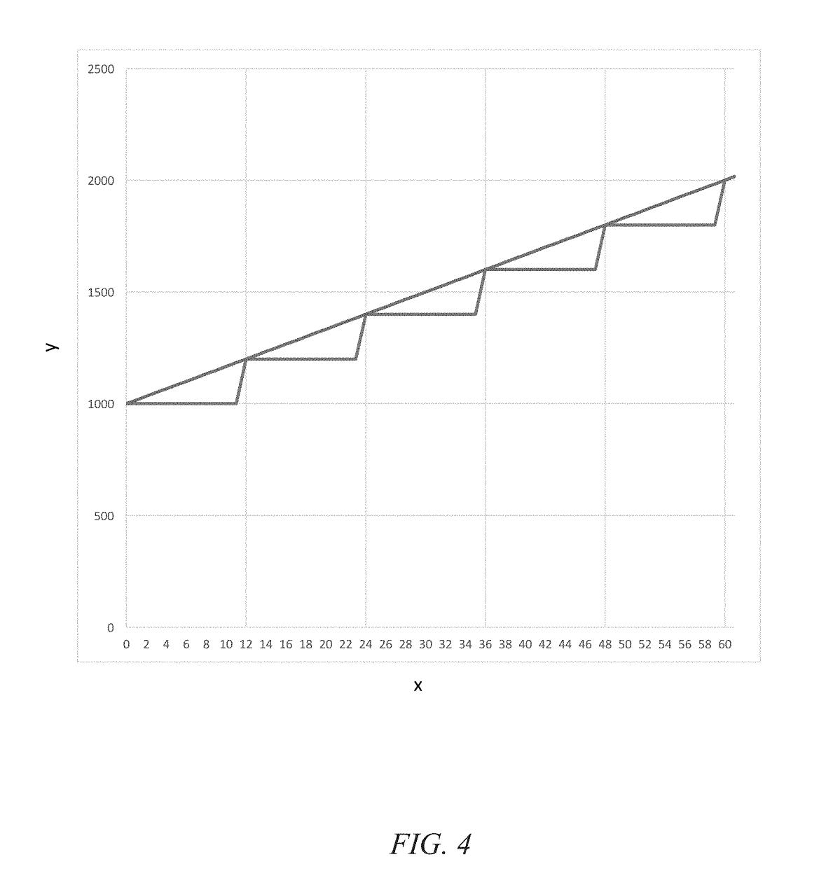

In embodiments of the present disclosure, corrected interrogated pressure altitude (y) may be calculated over time (x), as depicted in FIG. 4. A transceiver, such as an ADS-B, may be a GPS-based system and may include an ADS-B output transmitter that may transmit an aircraft's GPS position and altitude. The GPS may be utilized by the transceiver and may update the aircraft's position in space at least every second. It should be appreciated that aircraft position may be updated any number of seconds using the GPS without departing from the present disclosure. By using the GPS altitude to correct the transponder pressure altitude, an accurate 1-second updated pressure altitude may be transmitted via the output transmitter. It should be appreciated that utilizing an altitude sensor onboard a universal access transceiver (UAT) or a transceiver may also update aircraft position in space at least approximately every second, even if a GPS is not utilized. It should be appreciated that aircraft position must be updated any number of seconds using the altitude sensor without departing from the present disclosure. The GPS altitude may be utilized to correct the pressure altitude provided by the transponder. It should be appreciated that a corrected pressure altitude may be accurate when the altitude is updated by the GPS. The corrected pressure altitude may be transmitted via the transceiver output, such as, ADS-B OUT. The ATCRBS may interrogate a transponder, and a transponder monitoring device, such as TransMon, may receive the transponder interrogated pressure altitude (TIPA) or a first transponder interrogated pressure altitude. Concurrently, the transceiver GPS altitude or subsequent position may be saved approximately every second and may be designated by GPSA(n). It should be appreciated that the transceiver GPS altitude or subsequent position GPSA(n) may be determined at any desired time increments without departing from the present disclosure. When the GPS altitude is recorded at the same time as the ATCRBS interrogates the transponder, this GPS altitude or initial position may be designated by GPSA(0). During periods of time between the ATCRBS transponder interrogations, the transceiver may transmit the corrected pressure altitude which may be calculated by adding the TIPA and GPSA(n) and subtracting the GPSA(0) [Corrected Altitude Pressure=TIPA+GPSA(n)−GPSA(0)]. For example, an aircraft may climb or ascend at a rate of 1000 feet per minute. Before the aircraft ascends, the ATCRBS radar may interrogate the transponder and the connected pressure altitude encoder which may provide a pressure altitude of 1000 feet. If the GPS altitude or the initial position is approximately 900 feet, then the GPS altitude may increase by a climb or ascend rate of approximately 1000 feet per minute or 17 feet per second. The transceiver may transmit the corrected pressure altitude, T(n), [T(n)=TIPA+GPSA(n)−GPSA(0)] which may be approximately 1000 feet at zero seconds [T(0)=1000 feet+900 feet−900 feet=1000 feet], 1017 feet at 1 second [T(1)=1000 feet+917 feet−900 feet=1017 feet], 1033 feet at 2 seconds [T(2)=1000 feet+933 feet−900 feet=1033 feet], etc. It should be appreciated that the pressure altitude and the GPS altitude may be provided in any desired units of measurement.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A transponder monitoring system for correcting pressure altitude, the system comprising:
a transponder provided to transmit a signal to an air traffic control station;
a plurality of transmitters provided to transmit an initial position and a first transponder interrogated pressure altitude; and
a global positioning system (GPS) provided to automatically correct the first transponder interrogated pressure altitude to a corrected pressure altitude and determine a subsequent position.

2. The system of claim 1, further comprising:
an air traffic control ground radar provided to rotate at a fixed rate and interrogate the transponder.

3. The system of claim 2, wherein the corrected pressure altitude and the subsequent position are automatically recorded when the transponder is interrogated by the air traffic control ground radar.

4. The system of claim 1, wherein the transponder transmits encoded information, and wherein the encoded information includes the initial position and the first transponder interrogated pressure altitude.

5. The system of claim 1, wherein the GPS determines the subsequent position and corrects the first transponder interrogated pressure altitude to the corrected pressure altitude approximately every second.

6. The system of claim 1, further comprising:
an RF coupler provided to monitor transponder transmissions, decode the first transponder interrogated pressure altitude and the corrected pressure altitude, a reply code and identity information, and transmit the first transponder interrogated pressure altitude and the corrected pressure altitude, and the reply code and identity information digitally for use by a transceiver.

8. The system of claim 1, further comprising:
an ADS-B OUT transmitter provided to transmit the corrected pressure altitude,
wherein the corrected pressure altitude is a sum of the first transponder interrogated pressure altitude and the subsequent position minus the initial position, and
wherein the corrected pressure altitude is calculated by T(n)=TIPA+GPS(n)−GPS(0).

9. The system of claim 1, wherein the initial position is determined when zero seconds have elapsed and the air traffic control ground radar interrogates the transponder and a connected pressure altitude encoder.

10. A method for correcting pressure altitude, the method comprising:
transmitting a signal to an air traffic control station using a transponder;
transmitting an initial position and a first transponder interrogated pressure altitude using a plurality of transmitters; and
automatically determining a subsequent position and correcting the first transponder interrogated pressure altitude to a corrected pressure altitude using a global positioning system (GPS).

11. The method of claim 10, further comprising:
rotating an air traffic control ground radar at a fixed rate and interrogating the transponder.

12. The method of claim 11, further comprising:
automatically recording the subsequent position and the corrected pressure altitude when the transponder is interrogated by the air traffic control ground radar.

13. The method of claim 11, further comprising:
transmitting encoded information by the transponder, wherein the encoded information includes the initial position and the first transponder interrogated pressure altitude.

14. The method of claim 11, further comprising:
updating the first transponder interrogated pressure altitude to the corrected pressure altitude and determining the subsequent position approximately every second using the GPS.

15. The method of claim 11, further comprising:
monitoring transponder transmissions, decoding the first transponder interrogated pressure altitude, the corrected pressure altitude, a reply code and identity information, and transmitting the first transponder interrogated pressure altitude, the corrected pressure altitude, the reply code and identity information digitally for use by a transceiver using an RF coupler.

16. The method of claim 11, further comprising:
transmitting the corrected pressure altitude using an ADS-B OUT transmitter; and
calculating, by a computer, the corrected pressure altitude, wherein the corrected pressure altitude is a sum of the first transponder interrogated pressure altitude and the subsequent position minus the initial position represented by T(n)=TIPA+GPS(n)−GPS(0).

17. The method of claim 11, further comprising:
calculating, by a computer, the initial position when zero seconds have elapsed and the air traffic control ground radar interrogates the transponder and a connected pressure altitude encoder.

18. A pressure altitude correction device comprising:
a transponder provided to transmit a signal to an air traffic control station;
a plurality of transmitters provided to transmit an initial position and a first transponder interrogated pressure altitude;
a global positioning system (GPS) provided to automatically determine a subsequent position and correct the first transponder interrogated pressure altitude to a corrected pressure altitude; and
an RF coupler provided to monitor transponder transmissions, decode the first transponder interrogated pressure altitude, the corrected pressure altitude, a reply code and identity information, and transmit the first transponder interrogated pressure altitude, the corrected pressure altitude, the reply code and identity information digitally for use by a transceiver.

19. The device of claim 18, further comprising:
an ADS-B OUT transmitter provided to transmit the corrected pressure altitude, wherein the corrected pressure altitude is a sum of the first transponder interrogated pressure altitude and the subsequent position minus the initial position, represented by T(n)=TIPA+GPSA(n)−GPSA(0).

20. The device of claim 18, wherein the initial position is determined when zero seconds have elapsed and the air traffic control ground radar interrogates the transponder and a connected pressure altitude encoder.
